(19) United States
(12) Patent Application Publication
(10) Pub. No.: US 2024/0392413 A1
(43) Pub. Date: Nov. 28, 2024

(54) Methods Of Recycling Target Elements From Metallic Components

(71) Applicant: The Johns Hopkins University, Baltimore, MD (US)

(72) Inventors: Jarod C. Gagnon, Finksburg, MD (US); Cheryl E. Sturm, Hillsborough, NJ (US); Scott A. Shuler, Baltimore, MD (US); Elizabeth A. Pogue, Laurel, MD (US)

(73) Assignee: The Johns Hopkins University, Baltimore, MD (US)

(21) Appl. No.: 18/668,459

(22) Filed: May 20, 2024

Related U.S. Application Data
(60) Provisional application No. 63/468,309, filed on May 23, 2023.

(51) Int. Cl. C22B 59/00; C22B 3/06; C22B 3/16; C22B 3/22; C22B 7/00

(52) U.S. Cl. CPC C22B 59/00; C22B 3/06; C22B 3/165; C22B 3/22; C22B 7/007

(57) ABSTRACT

Methods of recycling target elements include dissolving and/or alloying a metallic component, including one or more target elements, with liquid gallium to provide a gallium melt and exposing the gallium melt with a liquid medium to form an intermediate liquid. The liquid medium is different than the gallium melt. The method also includes adjusting a pH value of the liquid medium to a first target pH and/or adjusting an applied electrical potential value to the intermediate liquid to a first target applied electrical potential, where at least a first portion of an initial total quantity of a first target element is present in a soluble form in the liquid medium. The method further includes isolating the liquid medium from the intermediate liquid to provide a first leachate, and separating the first target element from the first leachate.

### CROSS-REFERENCE TO RELATED APPLICATIONS

This application claims priority to and the benefit of prior-filed, co-pending U.S. Provisional Application No. 63/468,309, filed on May 23, 2023, the entire content of which is herein incorporated by reference.

### TECHNICAL FIELD

Example embodiments relate generally to methods of recycling or recovering target elements from metallic components by dissolving and/or alloying the metallic components with liquid gallium, and selectively isolating or recovering one or more target elements from the metallic components.

### BACKGROUND

The increasing use of electronics and disposal thereof is driving a need for viable and, preferably, environmentally friendly method of handling such end-of-life electronics and other such materials. The ever-increasing use and disposal of electronics presents a global concern due to the production of tons of such end-of-life electronic waste per year. The land-filling of electronic waste may generate hazardous effects on living organisms and ecosystems. As such, advancements in recycling techniques of such electronic devices is currently of great interest. Such recycling techniques aim to recover base and critical elements from electronic scraps for reuse. As such, the ability to efficiently recover and/or recycle a variety of chemical elements critical to the electronics industry will not only reduce the mining of these elements from natural resources but also reduces the contamination caused by the hazardous chemicals (mostly organic micro pollutants) released from these wastes when improperly disposed of at the end of use.

In general, current technologies that are being explored involve separating and crushing electronic components through physical means, then chemically dissolving and isolating key components through novel molecules. These technologies require synthesis of novel chemistries and can create hazardous waste streams associated with chemicals used for material dissolution. Moreover, the advancement in such recycling techniques has effectively stalled. For example, only about 17 percent (%) of electronic waste was recycled in 2014, while only 17.4% was recycled in 2019. As one specific example, only about 1% of neodymium (Nd), which is often found in magnets, was recycled in 2022. However, 90,000 tons of neodymium magnets (also referred to as NdFeB [neodymium, iron, boron], NIB, or Neo magnets) are forecasted to enter the global waste stream each year by 2030. Similar challenges are associated with the need to recover and/or recycle a variety of rare earth metals.

Therefore, there remains a substantial need in the art for a method of recovering and/or recycling a variety target chemical elements incorporate within a variety of waste components.

### BRIEF SUMMARY

One or more example embodiments solve one or more of the aforementioned problems. More particularly, example embodiments include a method of recycling target elements. The method includes providing a metallic component including one or more target elements, including a first target element present in an initial total quantity. The method further includes dissolving and/or alloying the metallic component with liquid gallium to provide a gallium melt including the first target element, and exposing the gallium melt with a liquid medium to form an intermediate liquid, where the liquid medium is different than the gallium melt. The method further includes identifying a first target window, where the first target element is soluble in the liquid medium and the first target window is defined by a set of pH values for the liquid medium and a stability region of the liquid medium. The method further includes adjusting a pH value of the liquid medium to a first target pH within the first target window and/or adjusting an applied electrical potential value to the intermediate liquid to a first target applied electrical potential within the first target window. At least a first portion of initial total quantity of the first target element is present in a soluble form in the liquid medium. The method further includes isolating the liquid medium from the intermediate liquid to provide a first leachate, and separating the first target element from the first leachate.

### BRIEF DESCRIPTION OF THE DRAWINGS

Example embodiments will be described more fully hereinafter with reference to the accompanying drawings, in which some, but not all, example embodiments are shown. Indeed, the example embodiments disclosed herein may be alternatively embodied in many different forms and should not be construed as limited to the specific embodiments set forth herein; rather, these embodiments are provided so that this disclosure will satisfy applicable legal requirements. Like numbers refer to like elements throughout, and wherein:

FIG. 1 illustrates a method of recycling one or more target elements according to an example embodiment;

FIGS. 2A and 2B illustrate examples of Pourbaix diagrams (also known as potential/pH diagrams) for systems and methods according to example embodiments;

FIG. 2C illustrates a simplified Pourbaix diagram restricted to the water stability region only for ease of identification in systems and methods according to example embodiments;

FIG. 3A is a table summarizing a group of experimental runs targeting the recovery of neodymium (Nd) in systems and methods according to example embodiments;

FIG. 3B illustrates a plot of the percent (%) neodymium (% Nd) recovered for a series of experimental runs as well as the neodymium:iron (Nd:Fe) enhancement factor for experimental runs in systems and methods according to example embodiments;

FIG. 4A illustrates the observed effect of time on leachate yield for Nd % recovery in systems and methods according to example embodiments;

FIG. 4B illustrates the observed effect of time on leachate yield for praseodymium (Pr) % recovery in systems and methods according to example embodiments; and

FIG. 4C illustrates the observed effect of time on leachate yield for iron (Fe) % recovery in systems and methods according to example embodiments.

### DETAILED DESCRIPTION

Example embodiments will now be described more fully with reference to the accompanying drawings. As used herein, and in the appended claims, the singular forms “a,” “an,” and “the” include plural referents unless the context clearly dictates otherwise.

Example embodiments generally relate to methods of recycling or recovering target materials, e.g., target elements (though alternative example embodiments are not limited thereto), from metallic components. In accordance with example embodiments, the methods exploit the natural affinity of gallium (e.g., in liquid form) to dissolve and/or alloy with a wide variety of metals (e.g., metallic components). Gallium, for example, forms alloys with most metals. Moreover, gallium readily diffuses into cracks or grain boundaries of a variety of metals such causing extreme loss of strength and ductility called liquid metal embrittlement. By way of example only, the metals may be incorporated into a variety of end-of-life devices, such as electronics, magnets, electrodes, etc. After dissolution and/or alloying with liquid gallium, a variety of subsequent physical and/or chemical methods may be performed to separate out key chemical elements from the dissolved and/or alloyed stock for recovery of desired chemical elements (e.g., technology-critical elements). The combined alloys and/or amalgams of gallium and dissolved elements can melt at a much lower temperature than the core electronic waste due to the low melting temperature and easy alloy formation with gallium. The methods may then include separating out the critical harvested elements from the gallium alloy (or intermediate liquid) through a series of different methods including, but not necessarily limited to, hydrolytic separation, electrolytic separation, chemical separation, or density separation depending on the properties of the alloys and individual components. Moreover, the methods may include or allow the recovery of the gallium for subsequent use as opposed to etching of the gallium.

Stated somewhat differently, the method in accordance with example embodiments may leverage the natural ability of gallium to create low-temperature alloys with many metals to harvest key chemical elements from recycled waste material including, but not limited to, electronic waste and magnetic components. As noted above, previous technological approaches that have been explored involve separating and crushing electronic components through physical means, then chemically dissolving and isolating key components through novel molecules. Such technologies require synthesis of novel chemistries and can create hazardous waste streams associated with chemicals used for material dissolution. To the contrary, example embodiments use primarily gallium to dissolve and/or alloy key components (e.g., chemical elements) with minimal (if at all) need for physical crushing and separation due to gallium specifically and readily dissolving and/or alloying with metals vs. plastic housing components. Selective separation of target chemical elements from gallium alloys (or intermediate liquids formed via a gallium melt and liquid medium) can then be performed through a variety of low-hazard methods including, for example, reaction with water to form metal oxides plus gallium metal, and use of acids/bases to adjust pH to selectively leach out target elements (e.g., metals), then precipitate, for example, key metal oxides. In both separation methodologies for this technology, all starting materials (i.e. gallium, acids, and bases) can be reused which significantly minimizes any associated waste streams as compared to other methods being explored.

In this regard, example embodiments provide low temperature metallurgical recycling having desirable selectivity and yield relative to traditional approaches through pH control and/or applied voltages (e.g., controlling electrical potential) in conjunction with alloy/solution formation. Accordingly, methods in accordance with example embodiments may provide a new resource stream for technological critical elements, which will significantly reduce reliance on new mining and create a secure supply chain now and in the future. Such a new resource stream could be invaluable given the increasing competition for a relatively fixed amount of such materials mined per year.

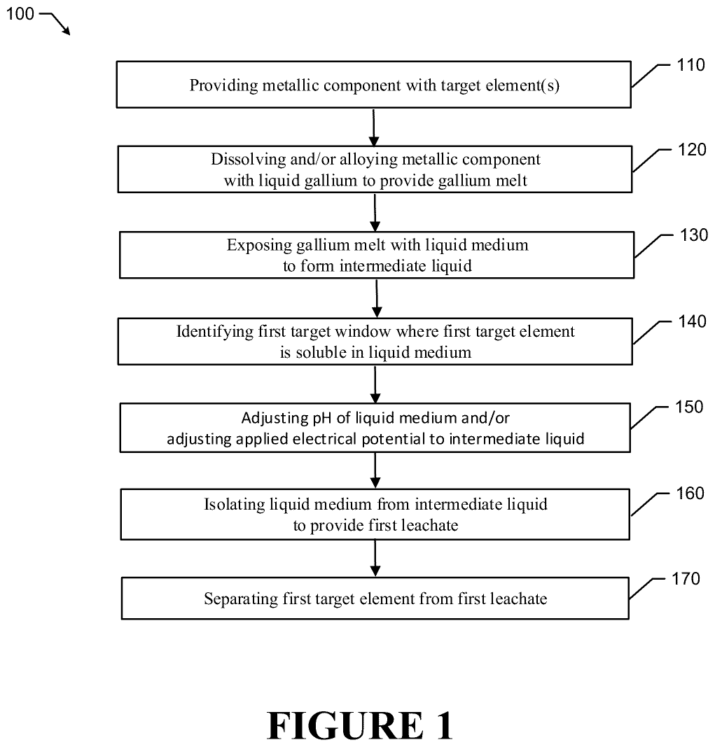

As shown in FIG. 1, example embodiments include a method 100 of recycling one or more target elements, in which the method may include the following: (i) providing a metallic component including one or more target elements including a first target element present in an initial total quantity (Step 110); (ii) dissolving and/or alloying the metallic component with liquid gallium to provide a gallium melt including the first target element (Step 120); (iii) exposing the gallium melt with a liquid medium to form an intermediate liquid, wherein the liquid medium is different than the gallium melt (Step 130); (iv) identifying a first target window where the first target element is soluble in the liquid medium, the first target window being defined by a set of pH values for the liquid medium and a stability region of the liquid medium (Step 140); (v) adjusting a pH value of the liquid medium to a first target pH within the first target window and/or an applied electrical potential value to the intermediate liquid to a first target applied electrical potential within the first target window, wherein at least a first portion of initial total quantity of the first target element is present in a soluble form in the liquid medium (Step 150); (vi) isolating the liquid medium from the intermediate liquid to provide a first leachate (Step 160); and (vii) separating the first target element from the first leachate (Step 170).

In accordance with example embodiments, the one or more target elements are technology-critical elements including (i) one or more rare-earth elements, such as cerium, dysprosium, erbium, europium, gadolinium, holmium, lanthanum, lutetium, neodymium, prascodymium, promethium, samarium, scandium, terbium, thulium, ytterbium, and yttrium; (ii) one or more platinum-group elements, such as iridium, osmium, palladium, platinum, rhodium, and ruthenium; (iii) one or more assorted elements, such as antimony, beryllium, cesium, cobalt, gallium, germanium, indium, lithium, niobium, tantalum, tellurium, and tungsten, and (iv) any combinations of (i), (ii), and (iii). In this regard, the one or more target elements may be constituted as an alloy within one or more metallic components for recycling. By way of example, the one or more target elements may be incorporated into one or more metal components present within, for example, an end-of-life device, such as an electronics component, a magnet, an electrode, or a solid-state electrolyte.

In accordance with example embodiments, an amount of liquid gallium utilized to dissolve and/or alloy the metallic component may include a first ratio between the mass of the liquid gallium and the mass of the electronic component (e.g., mass of the metallic components present within the electronic component) from about 0.5:1 to about 10:1, such as at least about any of the following: 0.5:1, 0.75:1, 1:1, 1.5:1, 2:1, 3:1, 4:1, and 5:1, and/or at most about any of the following: 10:1, 9:1, 8:1, 7:1, 6:1, and 5:1. Additionally or alternatively, the dissolving and/or alloying of the metallic component with liquid gallium may be conducted at a temperature from about 30 degrees(°) Celsius (C.) to about 2000° C., such as at least about any of the following: 30, 40, 50, 80, 100, 200, 300, 400, 500, 600, 700, 800, 900, and 1000° C., and/or at most about any of the following: 2000, 1900, 1800, 1700, 1600, 1500, 1400, 1300, 1200, 1100, and 1000° C. Additionally or alternatively, dissolving and/or alloying the metallic component with liquid gallium may be conducted for a residence time from about 1 minute to about 168 hours, such as at least about any of the following: 0.01, 0.02, 0.05, 0.1, 0.5, 1, 2, 5, 8, 10, 15, 20, 25, 30, 40, 50, 60, and 70 hours, and/or at most about any of the following: 168, 160, 150, 140, 130, 120, 110, 100, 90, 80, and 70 hours. In accordance with example embodiments, the step of dissolving and/or alloying the metallic component may be performed under agitation or without. Additionally or alternatively, the method may optionally include a step of physically crushing the end-of-life device prior to dissolving and/or alloying of the metallic component with liquid gallium.

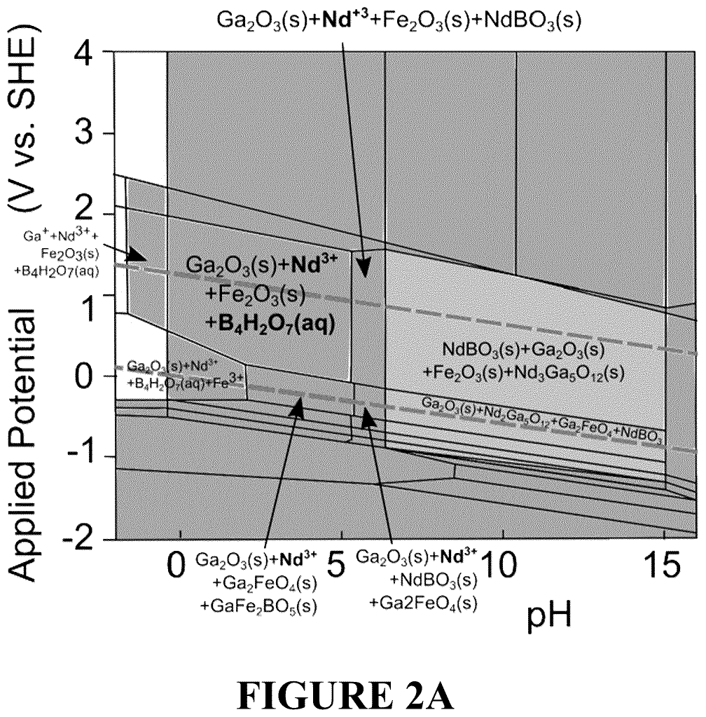

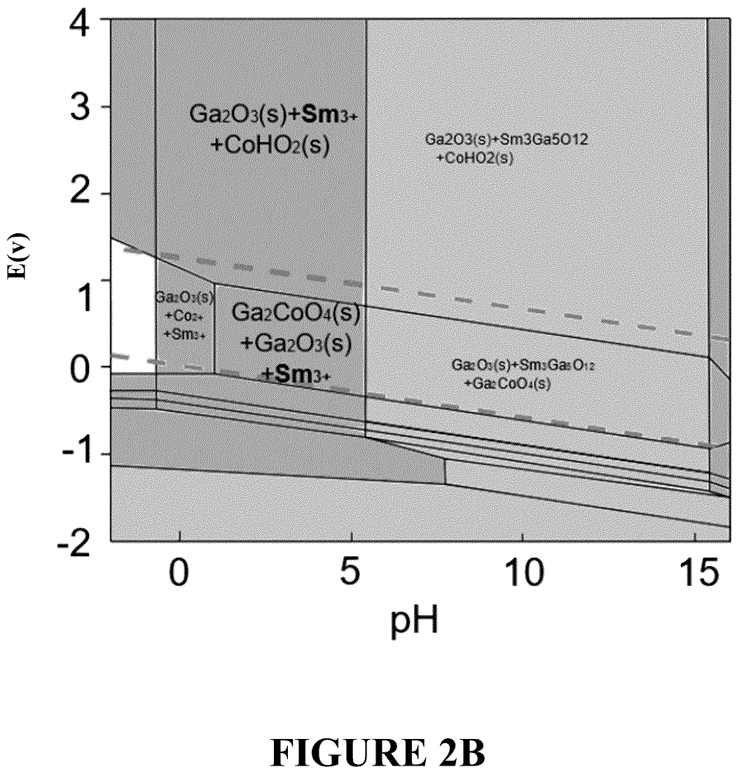

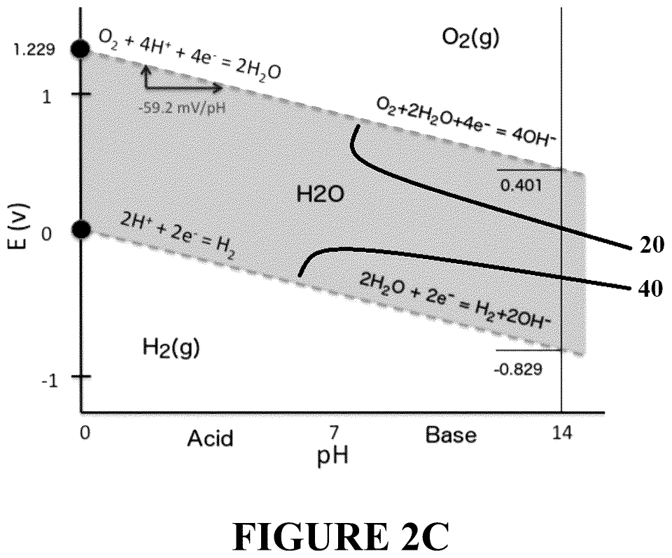

The gallium melt may be exposed to a liquid medium, which may vary in constituents, to form the intermediate liquid. The liquid medium, for example, may include an aqueous-based medium, a non-aqueous-based medium, or a combination thereof. Preferably, the liquid medium has a relatively broad stability region. For example, a Pourbaix diagram for a given system maps-out or defines plot of possible thermodynamically stable phases (i.e., at chemical equilibrium) of an electrochemical system (e.g., aqueous system). Boundaries (e.g., equilibrium conditions) between the predominant chemical species (aqueous ions in solution, or solid phases) are represented by lines. As such, a Pourbaix diagram can be read much like a standard phase diagram with a different set of axes. Similarly to phase diagrams, they do not allow for reaction rate or kinetic effects. Beside electrical potential and pH, the equilibrium concentrations may also dependent upon, e.g., temperature, pressure, and concentration. Pourbaix diagrams are commonly given at room temperature, atmospheric pressure, and molar concentrations of 10⁻⁶ and changing any of these parameters will yield a modified diagram, which can be prepared experimentally by one of skill in the art. FIGS. 2A and 2B illustrate examples of Pourbaix diagrams for different systems according to example embodiments. As can be seen in FIGS. 2A and 2B, the relative stability of different species may be selected by controlling/modifying the pH (X-axis) and/or the applied potential, e.g., voltage potential [V or E(v)] with respect to the standard hydrogen electrode (SHE) (Y-axis). By controlling one or both of these variables, a user may selectively extract or isolate a target element (e.g., in ionic or complexed form) from all or many of the other elements from the original intermediate liquid. As such, electrochemical separation of target elements can be achieved. The pH of the liquid medium (e.g., aqueous-based) may be controlled by the simply addition of acids and/or bases to arrive at a desired pH value based, at least in part, on the Pourbaix diagram (e.g., stock or internally developed for a given system at given process conditions, such as temperature and pressure) for the particular system. The applied voltage to the intermediate liquid may be manipulated by insertion of an electrode and/or by the addition of oxidizing and/or reducing agents.

FIGS. 2A and 2B also include a pair of dashed lines extending downwardly from and to the right from the Y-axis (i.e., applied potential). These dashed lines define the stability region for the liquid medium, such as water. Although the liquid medium may be embodied by a variety of aqueous and/or non-aqueous liquids, for the sake of case in discussion the stability region on a Pourbaix diagram for water will be highlighted with reference to FIG. 2C. As shown in FIG. 2C, the limits of stability of water (the liquid medium) are defined by the two dashed lines 20 and 40. In this regard, the stability region for water falls between these two lines 20 and 40. It should be noted that FIG. 2C is a simplified Pourbaix diagram restricted to the water stability region only for case of identification. As illustrated by FIG. 2C, pH and applied potential/voltage E(v) combinations falling above line 20 result in the formation of oxygen gas, while pH and applied voltage combination falling below line 40 result in the formation of hydrogen gas. As such, the stability region of the given liquid should be considered in conjunction with controlling the pH of the liquid medium and/or the applied voltage to the intermediate liquid to avoid pushing the system to a set of conditions in which the liquid medium is undesirably unstable.

In accordance with example embodiments, the liquid medium may include an aqueous-based medium including from about 50 to about 100 percent (%) by weight of water based on a total weight of liquid constituents forming the aqueous-based medium, such as at least about any of the following: 50, 60, 70 and 75% by weight, and/or at most about any of the following: 100, 98, 95, 92, 90, 85, 80, and 75% by weight. The total weight of liquid constituents forming the aqueous-based medium, for example, may further include one or more co-solvents that are at least partially miscible, such as freely miscible, with water. By way of example, the one or more co-solvents has a dipole moment of at least 1.3 debyes (D), such as at least about any of the following: 1.3, 1.4, 1.5, 1.6, 1.8, 2, 2.5, 3, 3.5, 4, 4.5, 5, 5.5, and 6 D.

In accordance with example embodiments, the liquid medium may include a non-aqueous-based medium including from about 50 to about 100% by weight of one or more non-aqueous-based liquids based on a total weight of liquid constituents forming the non-aqueous-based medium, such as at least about any of the following: 50, 60, 70 and 75% by weight, and/or at most about any of the following: 100, 98, 95, 92, 90, 85, 80, and 75% by weight. Additionally or alternatively, the one or more non-aqueous-based liquids may have a stability region across the pH range of 0-14 of no more than 30% less of the stability region of water or greater than the stability region of water, such as no more than 25%, 20%, 15%, 10%, or 5% less than the stability region of water or greater than the stability window of water. By way of example only, the one or more non-aqueous-based liquids may include ethyl acetate, ethylene carbonate, propylene carbonate, or any combination thereof.

As noted above, the pH of the liquid medium may be selectively adjusted to manipulate the state and location of the target element for recycling. Adjusting a pH value of the liquid medium to the first target pH, for example, may include adding an acid and/or base to the liquid medium. The acid, for example, may include an inorganic acid, an organic acid, or a combination thereof. By way of example only, the organic acid, if used, may include 1, 2, or 3 carboxyl groups. A non-exhaustive list of example organic acids that may be used in accordance with example embodiments include lactic acid, acetic acid, formic acid, citric acid, oxalic acid, uric acid, malic acid, tartaric acid, butyric acid, folic acid or an combination thereof. A non-exhaustive list of example inorganic acids that may be used in accordance with example embodiments include hydrochloric acid, nitric acid, phosphoric acid, sulfuric acid, boric acid, hydrofluoric acid, hydrobromic acid, perchloric acid, hydroiodic acid, or any combination thereof.

In accordance with example embodiments, a concentration and volume of the acid added to the liquid medium may be based on the calculated total moles of all present metal elements, and wherein the volume of the acid is provided in stoichiometric excess of the calculated total moles of all present metal elements. For instance, the volume of the acid may be provided in stoichiometric excess of the calculated total moles of all present metal elements, such as at least about any of the following: 1.5 times (×), 2×, 4×, and 6× stoichiometric excess of the calculated total moles of all present metal elements, and/or at most about any of the following: 15×, 12×, 10×, 8×, and 6× stoichiometric excess of the calculated total moles of all present metal elements.

By way of example only, the following guidance for the calculation of acetic acid for the addition in accordance with example embodiments if provided. In this regard, acetic acid concentrations and volumes may be prepared based on two guiding principles: (1) the pH of the acetic acid solution falls within the correct Pourbaix diagram window (e.g., region); and (2) the total acetic acid solution volume used is in stoichiometric excess of the total moles of all metal ions. For example, the computational Pourbaix diagram based on one neodymium (e.g., NdFeB) magnet composition shows Nd(OAc)₃ is soluble at pH of 3 whereas all other metal species are solid precipitates. The moles of all metal ions were calculated in the sample, and add enough acetic acid solution to exceed the moles of metal ion in 10 times excess. This excess of acetic acid solution is used to account for variations in oxidation states of the metal ions, which affects the number of acetate ligands per metal center. To improve efficiency of materials, once a near 100% yield was obtained and the process was standardized, the amount of acetic acid was decreased based on the solubility of the target compounds (e.g. neodymium acetate) to ensure the minimum amount of acetic acid is used to maintain solubility of the target compounds while maintaining the total yield of the neodymium acetate in the leachate solution.

In accordance with example embodiments, the method may also include agitating the intermediate liquid before, and/or during, and/or after adjusting the pH value and/or electrochemical potential.

In accordance with example embodiments, the intermediate liquid may have a volume: volume ratio between the liquid medium and the gallium melt from about 0.5:1 to about 100:1, such as at least about any of the following: 0.5:1, 0.8:1, 1:1, 1.5:1, 2:1, 5:1, 10:1, 20:1, 30:1, 40:1, and 50:1, and/or at most about any of the following: 100:1, 80:1, 70:1, 60:1, and 50:1. In this regard, the ratio between the liquid medium and the gallium melt may be varied as needed, while a reduced amount of liquid medium may be desired from a material handling standpoint as long as the recovery yield of the target element(s) is not negatively impacted significantly.

The intermediate liquid, for example, may provide or otherwise form an interface between the liquid gallium and the liquid medium under agitation and/or without agitation to define a steeping residence time from about 1 to about 120 hours, such as at least about any of the following: 1, 5, 10, 20, 30, 40, 50, and 60 hours, and/or at most about any of the following: 120, 110, 100, 90, 80, 70, and 60 hours. For example, the intermediate liquid may be agitated or otherwise mixed and allowed to settle forming a liquid medium phase and a liquid gallium phase. Additionally or alternatively, during the steeping residence time the intermediate liquid may be maintained at an average steeping temperature from about 30° C. to about 120° C., such as at least about any of the following: 30, 35, 40, 45, 50, and 60° C., and/or at most about any of the following: 120, 100, 80, 75, 70, 65, and 60° C.

The method, in accordance with example embodiments, may include isolating the liquid medium from the intermediate liquid to provide a first leachate including decanting the liquid medium from the intermediate liquid. In this regard, the density of the liquid medium may be less than that of the liquid gallium in the intermediate liquid. Alternatively, the liquid gallium phase from the intermediate liquid may be drained out from the bottom of a tank housing the intermediate liquid and leaving the first leachate behind.

Once the first leachate has been obtained, the method may include separating the first target element from the first leachate. For example, the first target element may be separated from the first leachate by precipitating the first target element followed by performing a solid-liquid separation (e.g., filtration, centrifuge operation, etc.) to define a liquid mother liquor component and a first isolated precipitate containing the first target element.

By way of example, the first isolated precipitate may include a salt of the first target element. Additionally or alternatively, the first isolated precipitate may include an oxide of the first target element (e.g., metal oxide). In accordance with example embodiments, the first isolated precipitate may include an oxalate of the first target element (e.g., metal oxalate).

In accordance with example embodiments, the method may include combining a remaining gallium melt (e.g., liquid gallium phase remaining after the first target element has been recovered from the initial liquid gallium phase/melt) with a second liquid medium to form a second intermediate liquid. The second liquid medium, as well as any subsequent iterations of targeting subsequent target elements, may include any liquid medium described and disclosed herein. In this regard, the method may include identifying a second target window where a second target element, which is different than the first target element, is soluble in the second liquid medium. The second target window being defined by a second set of pH values for the second liquid medium and a second stability region of the second liquid medium, wherein the second liquid medium may be the same or different than the first liquid medium.

The method may include adjusting a pH value of the second liquid medium to a second target pH within the second target window and/or an applied electrical potential value to the second intermediate liquid to a second target applied electrical potential within the second target stability region, wherein at least a first portion of an initial total quantity of the second target element is present in a soluble form in the second liquid medium. Subsequently, the method may include a step of isolating the second liquid medium from the second intermediate liquid to provide a second leachate including the second target element. In a manner similar to that described above, the method may include a step of separating the second target element from the second leachate.

Accordingly, it should be understood that the method may include numerous sequential extractions or selective recovery of different target elements, such that each target element of interest is separately recovered from the other target elements and other metal materials. For instance, a metallic component(s) may include numerous (e.g., 2, 3, 4, 5, 6, etc.) different target elements for recovery/recycling. Methods in accordance with example embodiments provide a mechanism for selectively isolating and recovering one or more (e.g., all) of the potential target elements therein (either individually or in combination). By way of example only, a metallic component may include three (3) different target elements desirable for recovery and reuse. The method may enable the selective isolation and recovery of all three (3) target elements individually from each other. As such, the method may provide three (3) separate product streams each including an individual target element (e.g., either in a pure form or complexed as a salt, oxide, etc.).

After the desired number of target elements have been recovered from the original gallium melt, the method may include filtering the liquid gallium to remove any solid metallic particulates therefrom to provide a reclaimed liquid gallium for a subsequent dissolution and/or alloying of a subsequent metallic component. Additionally or alternatively, the method may include extracting all metal elements to provide a reclaimed liquid gallium for subsequent use.

### EXAMPLES

The present disclosure is further illustrated by the following examples, which in no way should be construed as being limiting. That is, the specific features described in the following examples are merely illustrative and not limiting.

### Example Set 1

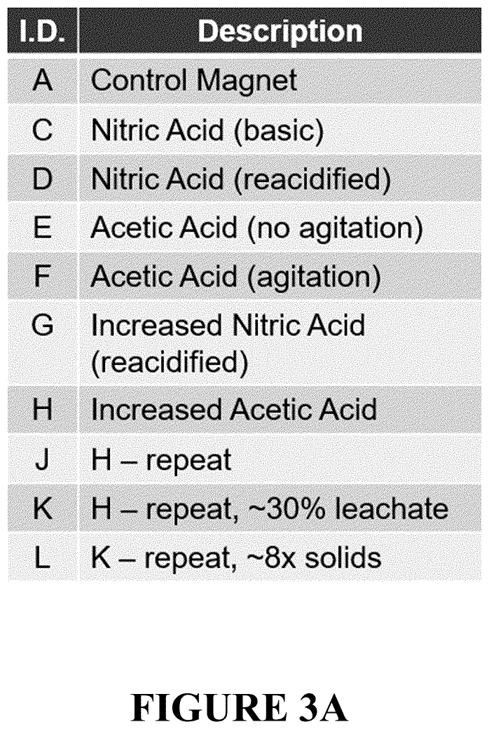

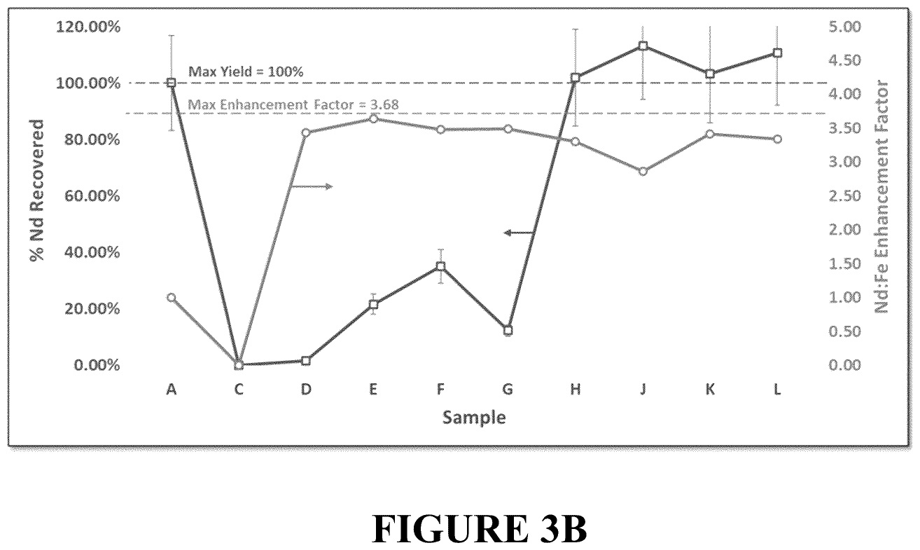

A series of experimental runs were conducted on Nd₂Fe₁₄B magnets (e.g., 3 millimeter [mm]×1 mm discs) for recovery of Nd. FIG. 3A illustrates the description for each experimental run, in which Run A was a control magnet. FIG. 3B illustrates a plot of the % Nd recovered (square data points) as well as the Nd: Fe enhancement factor (circle data points) for each run A through L. For instance, each magnet has an initial ratio between Nd and Fe wherein the enhancement factor may be defined as having a value of 1.0. In this regard, a yield for Nd as well as a general purity value may be evaluated.

Each leachate from each experimental run can be evaluated for both the amount of Nd present as well as the ratio between Nd and Fe. Gallium metal (>99% pure) was used to dissolve/alloy the magnets. Glacial acetic acid (0.25 molarity [M]) was used and the final concentration was variable based on target pH.

In the experimental runs C-H and J-L, the magnet was dissolved/alloyed with liquid gallium and exposed to an aqueous solution (e.g., the liquid medium discussed above). FIG. 3A provides a summary of the pH adjustment means (e.g., type of acid) and indication of agitation or not. The experimental runs E and Fused acetic acid, but not in excess as noted in the protocol described in this detailed description. For these samples, a set amount of liquid medium at the target pH was selected, but the specific amount of acetic acid was not calculated as defined above in this detailed description (e.g., excess acetic acid), leading to not enough acid to interact with all the target Nd in the alloy. The noted “increased acetic acid” for experimental runs H, J, K and L were determined according to the procedure noted above in the detailed description. As can be seen in FIG. 3B, experimental runs H, J, K, and L provided excellent yield for Nd as well as desirable purity levels.

For experimental run J, the magnet mass was 270 milligrams (mg), the gallium mass was 16.4 grams (g), and the leachate volume was 200 milliliters (mL). For experimental run K, the magnet mass was 270 mg, the gallium mass was 17.0 g, and the leachate volume was 63 mL. For experimental run L, the magnet mass was 2160 mg, the gallium mass was 124 g, and the leachate volume was 500 mL.

The foregoing experimental runs demonstrate that ability to selectively recover Nd in an environmentally safe and simple manner. The recovered Nd may be reused for production of future commercial devices.

### Example Set 2

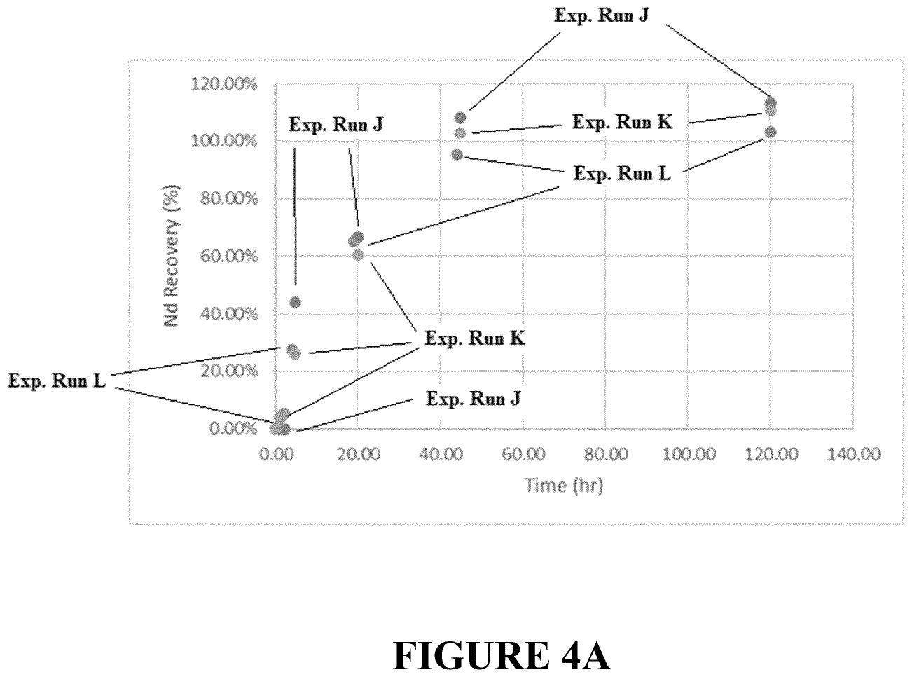

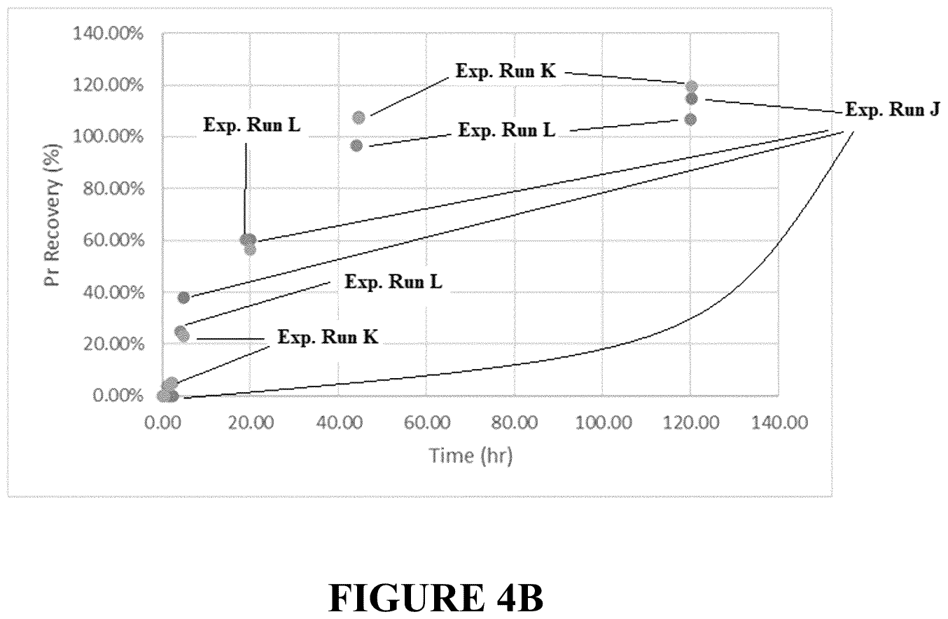

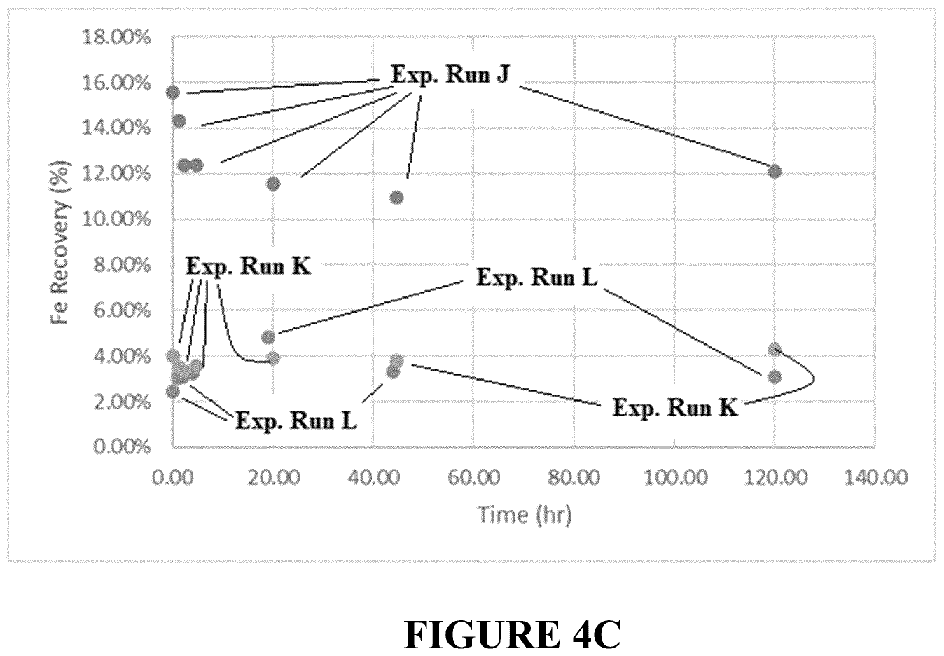

Utilizing experimental runs J, K, and L from Example Set 1, FIGS. 4A-4C illustrate the observed effect of time (e.g., steeping residence time discussed above) on leachate yield for Nd % recovery, prascodymium (Pr) % recovery, and iron (Fe) % recovery, respectfully. It should be noted that original Nd-based magnets often include a mix of Pr and Nd despite the nomenclature does not expressly list ‘Pr’. Each of the runs represented in FIGS. 4A-4C were conducted at a temperature of 50° C. The data from FIGS. 4A-4C illustrate that 100% yields in the leachate can be achieved after 48 hours (e.g., residence time) at 50° C. Each of the above plots of FIGS. 3A-3C were generated using the same experimental process outlined above in Example Set 1. For instance, the alloy (e.g., the gallium melt) was submerged in the liquid medium and sonicated for extended periods of time. Each of the data points were a time when a small amount of the leachate was pulled off of the sample and sent out for characterization of the three target elements (Nd, Pr, and Fe) via inductively coupled plasma mass spectroscopy (e.g., inductively coupled plasma-mass spectrometry [ICP-MS]). The reported data is the amount of each element in the leachate sample from that time period. It should be noted that sonication should have also increased the partial pressure of oxygen in the leachate due to aeration. This would affect the selectivity of the process by removing Fe from the leachate through reaction with oxygen (resulting in iron oxide). The data sets for FIGS. 3A-3C correspond to conditions for experimental runs J, K, and L (as labeled in the Figures).

In addition, it should be understood that aspects of the various example embodiments may be interchanged in whole or in part. Furthermore, those of ordinary skill in the art will appreciate that the foregoing description is by way of example only, and it is not intended to limit the invention as described in such appended claims. Therefore, the spirit and scope of the appended claims should not be limited to the exemplary description of the versions contained herein.

What is claimed is:

1. A method of recycling target elements, the method comprising:
(i) providing a metallic component including one or more target elements including a first target element present in an initial total quantity;
(ii) at least one of dissolving and alloying the metallic component with liquid gallium to provide a gallium melt including the first target element;
(iii) exposing the gallium melt with a liquid medium to form an intermediate liquid, wherein the liquid medium is different than the gallium melt;
(iv) identifying a first target window where the first target element is soluble in the liquid medium, the first target window being defined by a set of pH values for the liquid medium and a stability region of the liquid medium;
(v) adjusting at least one of a pH value of the liquid medium to a first target pH within the first target window and an applied electrical potential value to the intermediate liquid to a first target applied electrical potential within the first target window, wherein at least a first portion of initial total quantity of the first target element is present in a soluble form in the liquid medium;
(vi) isolating the liquid medium from the intermediate liquid to provide a first leachate; and
(vii) separating the first target element from the first leachate.

2. The method of claim 1, wherein the liquid medium comprises an aqueous-based medium, a non-aqueous-based medium, or a combination thereof.

3. The method of claim 1, wherein the one or more target elements are technology-critical elements comprising (i) one or more rare-earth elements, such as cerium, dysprosium, erbium, europium, gadolinium, holmium, lanthanum, lutetium, neodymium, praseodymium, promethium, samarium, scandium, terbium, thulium, ytterbium, and yttrium; (ii) one or more platinum-group elements, such as iridium, osmium, palladium, platinum, rhodium, and ruthenium; (iii) one or more assorted elements, such as antimony, beryllium, cesium, cobalt, gallium, germanium, indium, lithium, niobium, tantalum, tellurium, and tungsten, and (iv) any combinations of (i), (ii), and (iii).

4. The method of claim 1, wherein
(i) an amount of liquid gallium utilized to dissolve and/or alloy the metallic component comprises a first ratio between a mass of the liquid gallium and a mass of an electronic component from about 0.5:1 to about 10:1;
(ii) dissolving and/or alloying the metallic component with liquid gallium is conducted at a temperature from about 30° to about 2000°; and
(iii) wherein dissolving and/or alloying the metallic component with liquid gallium is conducted for a residence time from about 1 minute to about 168 hours.

5. The method of claim 1, wherein
adjusting a pH value of the liquid medium to the first target pH comprises adding one or more of an acid and a base to the liquid medium, and
the acid comprises an inorganic acid, an organic acid, or a combination thereof.

6. The method of claim 5, wherein the organic acid comprises lactic acid, acetic acid, formic acid, citric acid, oxalic acid, uric acid, malic acid, tartaric acid, butyric acid, folic acid or an combination thereof.

7. The method of claim 5, wherein the acid comprises an inorganic acid comprising hydrochloric acid, nitric acid, phosphoric acid, sulfuric acid, boric acid, hydrofluoric acid, hydrobromic acid, perchloric acid, hydroiodic acid, or any combination thereof.

8. The method of claim 5, wherein a concentration and a volume of the acid added to the liquid medium is based on a calculated total moles of all present metal elements, and wherein the volume of the acid is provided in stoichiometric excess of the calculated total moles of all present metal elements.

9. The method of claim 8, wherein the volume of the acid is provided in stoichiometric excess of a calculated total moles of the first target element.

10. The method of claim 1, wherein intermediate liquid has a volume: volume ratio between the liquid medium and the gallium melt from about 0.5:1 to about 100:1.

11. The method of claim 10, wherein the intermediate liquid provides an interface between the liquid gallium and the liquid medium to define a steeping residence time from about 1 to about 120 hours, and during the steeping residence time the intermediate liquid is maintained at an average steeping temperature from about 30° C. to about 120° C.

12. The method of claim 1, wherein isolating the liquid medium from the intermediate liquid to provide a first leachate comprises decanting the liquid medium from the intermediate liquid.

13. The method of claim 1, wherein separating the first target element from the first leachate comprises precipitating the first target element followed by performing a solid-liquid separation to define a liquid mother liquor component and a first isolated precipitate containing the first target element.

14. The method of claim 13, wherein the first isolated precipitate comprises a salt of the first target element, an oxide of the first target element, and/or an oxalate of the first target element.

15. The method of claim 12, further comprising combining a remaining gallium melt with a second liquid medium to form a second intermediate liquid.

16. The method of claim 15, wherein the liquid medium is a first liquid medium, and the method further comprises identifying a second target window where a second target element, which is different than the first target element, is soluble in the second liquid medium, the second target window being defined by a second set of pH values for the second liquid medium and a second stability region of the second liquid medium, wherein the second liquid medium may the same or different than the first liquid medium.

17. The method of claim 16, further comprising adjusting a pH value of the second liquid medium to a second target pH within the second target window and/or an applied electrical potential value to the second intermediate liquid to a second target applied electrical potential within the second target window, wherein at least a first portion of an initial total quantity of the second target element is present in a soluble form in the second liquid medium.

18. The method of claim 17, further comprising a step of isolating the second liquid medium from the second intermediate liquid to provide a second leachate including the second target element.

19. The method of claim 18, further comprising a step of separating the second target element from the second leachate.

20. The method of claim 12, further comprising filtering the liquid gallium to remove solid metallic particulates and/or extracting all metal elements to provide a reclaimed liquid gallium for subsequent use.
